(19) United States
(12) Patent Application Publication
(10) Pub. No.: US 2013/0199980 A1
(43) Pub. Date: Aug. 8, 2013

(54) ION EXCHANGE FILTER ASSEMBLY

(71) Applicant: MANN+HUMMEL GMBH, Ludwigsburg (DE)

(72) Inventor: Stuart Miller, Kalamazoo, MI (US)

(73) Assignee: MANN+HUMMEL GMBH, Ludwigsburg (DE)

(21) Appl. No.: 13/684,204

(22) Filed: Nov. 22, 2012

Related U.S. Application Data
(60) Provisional application No. 61/594,720, filed on Feb. 3, 2012.

(51) Int. Cl. B01D 35/18

(52) U.S. Cl. CPC B01D 35/18
USPC 210/182; 210/185

(57) ABSTRACT

An ion exchange filter assembly may include a housing adapted for receiving a coolant, an ion exchange filter containment region defined within the housing and adapted for housing an ion exchange filter and a coolant bypass passage defined within the housing. The ion exchange filter containment region may form a first coolant flow path within the housing and the coolant bypass passage may form a second coolant flow path in a parallel flow arrangement to the first coolant flow path.

### CROSS-REFERENCE TO RELATED APPLICATIONS

This application claims the benefit of U.S. Provisional Application No. 61/594,720, filed on Feb. 3, 2012. The entire disclosure of the above application is incorporated herein by reference.

### FIELD

The present disclosure relates to ion exchange filter assemblies.

### BACKGROUND

This section provides background information related to the present disclosure which is not necessarily prior art.

Ion exchange filter assemblies may be included in cooling systems to remove ions from coolant and prevent a short circuit in the system. External bypass loops and filters may be included in the systems to limit pressure drop across the ion exchange filter assembly and to remove particulate matter from the system.

### SUMMARY

This section provides a general summary of the disclosure, and is not a comprehensive disclosure of its full scope or all of its features.

An ion exchange filter assembly may include a housing adapted for receiving a coolant, an ion exchange filter containment region defined within the housing and adapted for housing an ion exchange filter and a coolant bypass passage defined within the housing. The ion exchange filter containment region may form a first coolant flow path within the housing and the coolant bypass passage may form a second coolant flow path in a parallel flow arrangement to the first coolant flow path.

In another arrangement, an ion exchange filter assembly may include a housing adapted for receiving a coolant, an ion exchange filter located within the housing and a coolant bypass passage defined within the housing external to the ion exchange filter. A first coolant flow path may be defined through the ion exchange filter and a second coolant flow path in a parallel flow arrangement to the first coolant flow path may be formed by the coolant bypass passage.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of an ion exchange filter assembly according to the present disclosure;

FIG. 2 is a perspective exploded view of the ion exchange filter assembly shown in FIG. 1;

FIG. 3 is a section view of the ion exchange filter assembly shown in FIG. 1 with the ion exchange filter schematically illustrated;

FIG. 4 is a top view of a portion of an ion exchange filter cartridge from the ion exchange filter assembly shown in FIG. 1;

FIG. 5 is a schematic fragmentary section view of the ion exchange filter from the ion exchange filter assembly shown in FIG. 1;

FIG. 6 is a schematic perspective exploded view of first and second sheets forming the ion exchange filter shown in FIG. 5;

FIG. 7 is a schematic perspective exploded view including an alternate second sheet for the ion exchange filter according to the present disclosure; and

FIG. 8 is a schematic illustration of a vehicle fuel cell system including the ion exchange filter assembly from FIG. 1.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

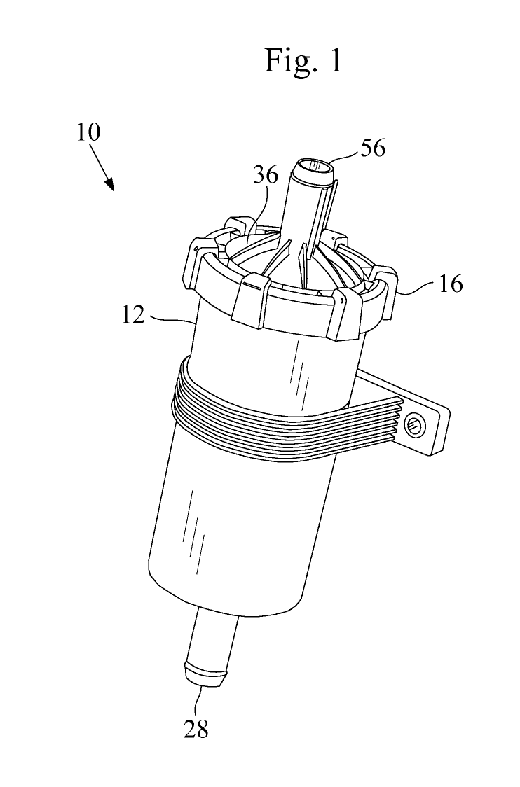

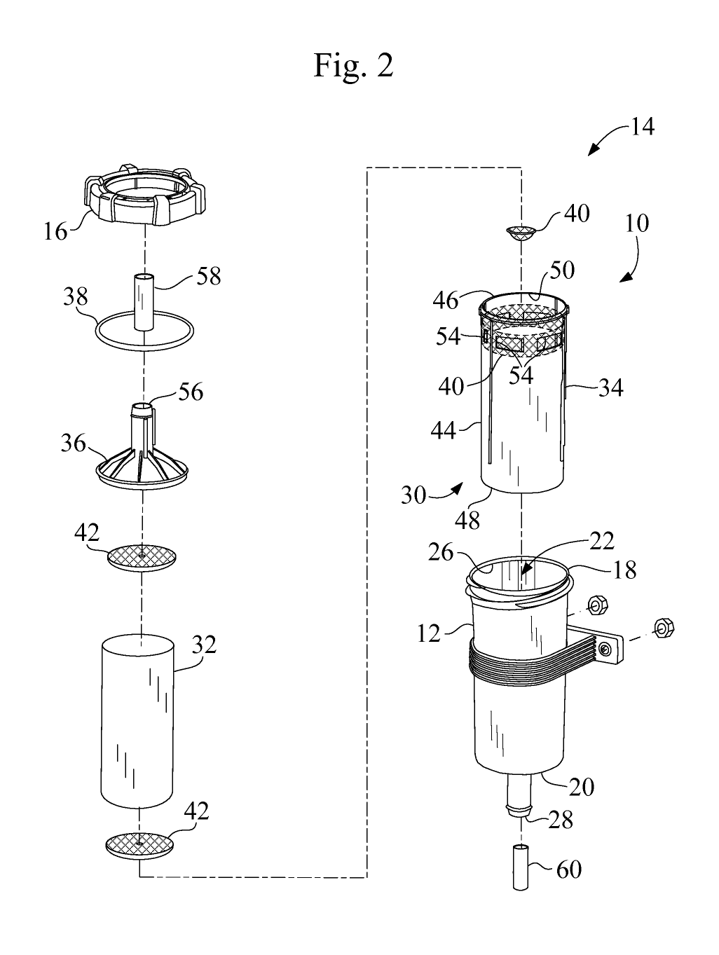

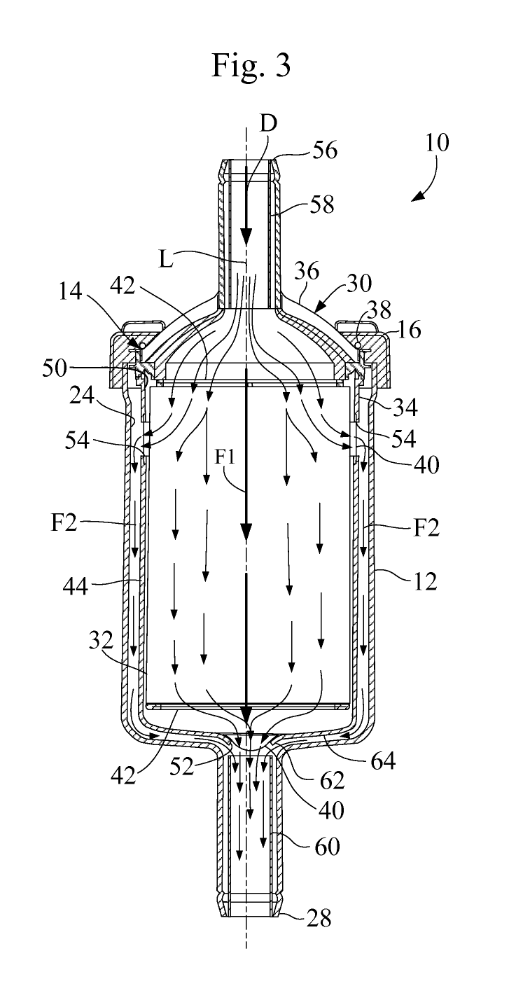

With reference to FIGS. 1-3, an ion exchange filter assembly 10 may include a housing 12, an ion exchange filter cartridge 14 and a fastening mechanism 16. The housing 12 may include a generally cylindrical body having first and second ends 18, 20 with an ion exchange filter containment region 22 and a coolant bypass passage 24 defined within the housing 12 between the first and second ends 18, 20. The first end 18 may define an opening 26 for receiving the ion exchange filter cartridge 14 and the second end 20 may define a coolant outlet 28 for the ion exchange filter assembly 10.

The ion exchange filter cartridge 14 may include a containment tube assembly 30 and an ion exchange filter 32 secured within the containment tube assembly 30. The containment tube assembly 30 may include a containment tube 34, an end cap 36, a seal 38, particle separation filters 40 and screens 42. The ion exchange filter cartridge 14 may be formed from a variety of polymers having a low total organic content (TOC) release during operation to maintain coolant conductivity within a desired range. The containment tube 34 may define an annular wall 44 having first and second longitudinal ends 46, 48. The first longitudinal end 46 may define an opening 50 that receives the ion exchange filter 32 and the second longitudinal end 48 may define an outlet opening 52 of the ion exchange filter cartridge 14. Coolant bypass inlets 54 may be defined radially through the annular wall 44 and may form part of the coolant bypass passage 24.

The particle separation filters 40 may be located within the housing 12 and may be in fluid communication with the coolant flow at a location before the coolant outlet 28. In the present non-limiting example, the particle separation filters are fixed to the ion exchange filter cartridge 14 with a particle separation filter 40 located at the outlet opening 52 and at the coolant bypass inlets 54. More specifically, the particle separation filters 40 may be integral to the containment tube 34 via an overmolding process. While described as being part of the ion exchange filter cartridge 14, it is understood that the present disclosure is not limited to such arrangements. Instead, one or more of the particle separation filters 40 may be located within the housing 12 external to the ion exchange filter cartridge 14.

The end cap 36 may be fixed to the first longitudinal end 46 and may define a coolant inlet 56 for the ion exchange filter assembly 10. The coolant inlet 56 may be in communication with the ion exchange filter containment region 22 and may also be in communication with the coolant bypass passage 24 via the coolant bypass inlets 54. The end cap 36 may be fixed to the containment tube 34 in a variety of ways including, but not limited to, welding. Strengthening or support members 58, 60 may be included in the coolant inlet 56 and the a coolant outlet 28, respectively. The seal 38 may be fixed on the end cap 36 and the fastening mechanism 16 may be engaged with the housing 12, the end cap 36 and the seal 38 to define a sealed coolant flow path from the coolant inlet 56 to the coolant outlet 28. More specifically, the fastening mechanism 16 may be in the form of a retaining ring threadably engaged with the housing 12.

The ion exchange filter assembly 10 may define a first coolant flow path (F1) within the housing 12 through the ion exchange filter containment region 22, and more specifically through the ion exchange filter 32, and a second coolant flow path (F2) within the housing 12 through the coolant bypass passage 24 and parallel to the first coolant flow path (F1). The first and second coolant flow paths (F1, F2) may each extend from the coolant inlet 56 to the coolant outlet 28. The annular wall 44 may extend longitudinally between the coolant inlet 56 and the coolant outlet 28 to separate the first and second coolant flow paths (F1, F2). The first coolant flow path (F1) may define a first inlet in communication with a second inlet defined by the second coolant flow path (F2) at the coolant inlet 56. The first coolant flow path (F1) may define a first outlet in communication with a second outlet defined by the second coolant flow path (F2) at the coolant outlet 28. The second coolant flow path (F2) may surround the first coolant flow path (F1) and may be concentric to the first coolant flow path (F1). The coolant bypass inlets 54 may define a passive flow control mechanism that meters coolant flow through the first and second coolant flow paths (F1, F2). For example, the coolant bypass inlet may be sized to meter coolant bypass flow and/or the particle separation filter 40 may be configured to restrict, limit or meter the coolant bypass flow to a desired percentage of the total coolant flow,

In the present non-limiting example, the ion exchange filter cartridge 14 is located within the ion exchange filter containment region 22 and cooperates with the housing 12 to define the coolant bypass passage 24. More specifically, the annular wall 44 separates and at least partially defines the ion exchange filter containment region 22 and the coolant bypass passage 24. While the ion exchange filter containment region 22 and the coolant bypass passage 24 are described as being at least partially defined by the ion exchange filter cartridge 14, it is understood that the present disclosure is not limited to such arrangements. A variety of alternate arrangements are within the scope of the present disclosure including, but not limited to, the annular wall 44 being part of the housing 12. The coolant bypass passage 24 may be defined at a location radially between an exterior of the annular wall 44 and an interior of the housing 12.

The first and second outlets defined by the first and second coolant flow paths (F1, F2) may be proximate one another. The second coolant flow path (F2) may generate a localized low pressure region in the coolant flow as the coolant from the second flow path (F2) flows past the first outlet, for example, by the venturi effect. In the present non-limiting example, the outlet of containment tube 34 includes an annular protrusion 62 extending longitudinally outward from a base region 64 of the containment tube 34. The bypass coolant flow passes the annular protrusion 62 and creates a localized low pressure region at the outlet opening 52 of the ion exchange filter cartridge 14 to assist in drawing coolant through the ion exchange filter 32.

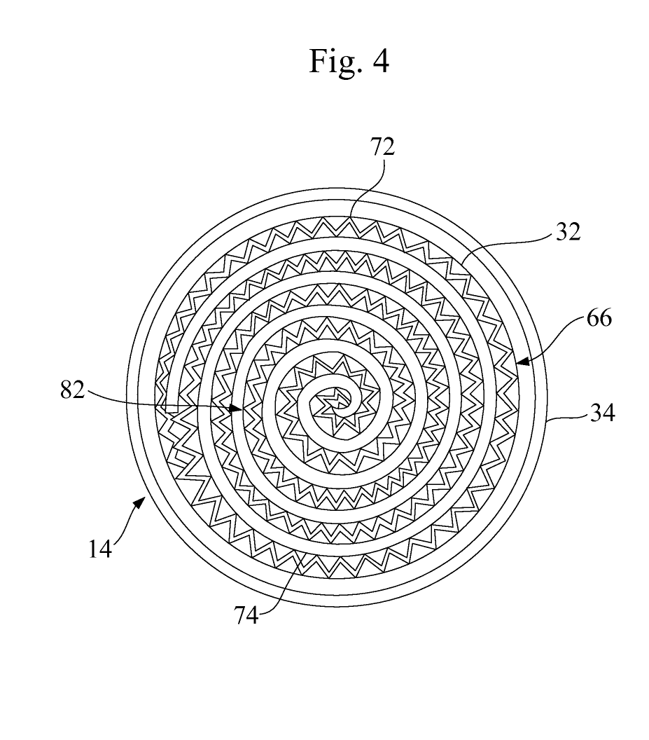

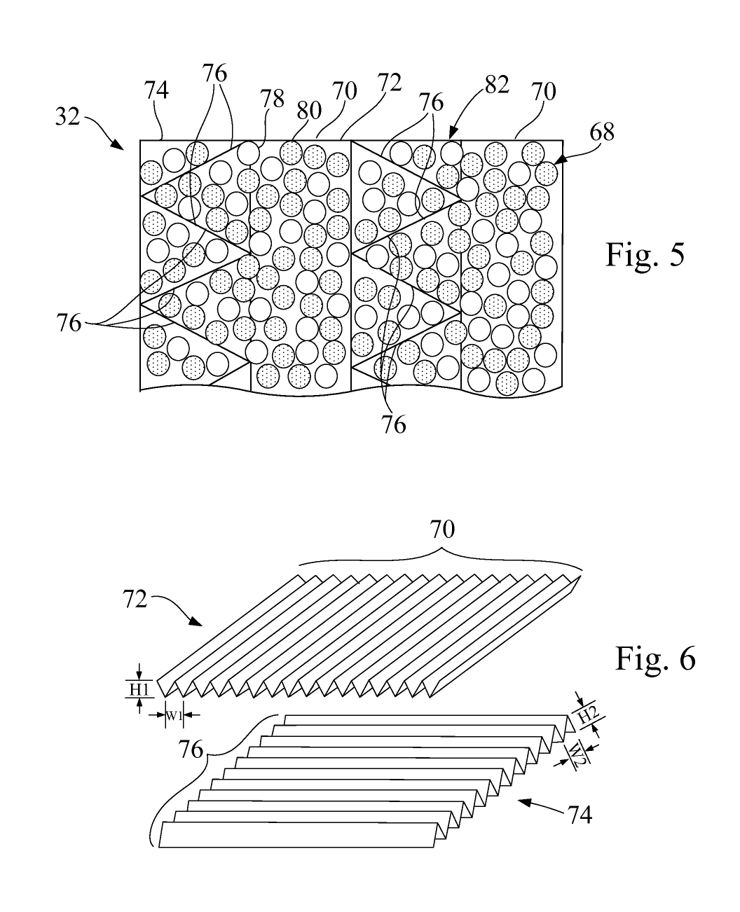

With reference also to FIGS. 4-6, the ion exchange filter 32 may include an ion exchange filter exoskeleton 66 and ion exchange resin beads 68. The screens 42 may be located at ends of the ion exchange filter exoskeleton 66 to contain the ion exchange resin beads 68 therein. The ion exchange filter exoskeleton 66 may include a porous body having a total porosity of at least fifty percent, and more specifically a total porosity of at least seventy-five percent. The ion exchange filter 32 may define a first set of channels 70 and the ion exchange resin beads 68 may be located in the first set of channels 70. The first set of channels 70 may extend generally parallel to a longitudinal axis (L) of the ion exchange filter 32 along a coolant flow direction (D) from an inlet of the ion exchange filter 32 to an outlet of the ion exchange filter 32.

The ion exchange filter exoskeleton 66 may include a first porous sheet 72 defining the first set of channels 70 and a second porous sheet 74 adjacent to the first porous sheet 72. In the present non-limiting example, the first and second porous sheets 72, 74 are formed from a pleated polypropylene spun-bond open media. The first and second porous sheets 72, 74 may be arranged to overlay face-to-face and wound to define the ion exchange filter exoskeleton 66. The first and second porous sheets 72, 74 may be wound with little or no slip experienced between the sheets due to a frictional engagement resulting from the porous structure of the first and second porous sheets 72, 74. The frictional engagement may eliminate the need for a fixed connection between the first and second porous sheets 72, 74 from an adhesive. While described as being wound, it is understood that the present disclosure is not limited to such arrangements and may take a variety of alternate forms including, but not limited to, a stacked sheet arrangement. Further, in either a wound or a stacked arrangement, the ion exchange filter exoskeleton 66 may be in the form of a cylinder as shown or may take a variety of alternate forms including, but not limited to, cylindrical or rectangular.

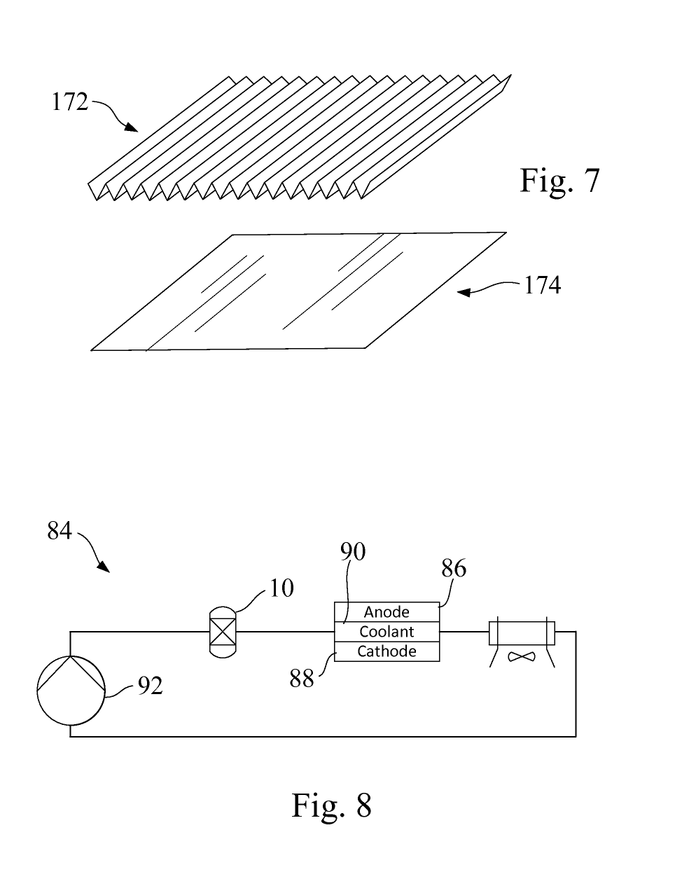

In the example shown in FIGS. 4-6, the second porous sheet 74 defines a second set of channels 76 oriented generally transverse relative to the first set of channels 70. However, and as seen in FIG. 7, it is understood that the present disclosure is not limited to such arrangements. For example, a generally flat second sheet 174 may be used in place of the second porous sheet 74. The generally flat second sheet 174 may be porous, similar to the second porous sheet 74. The first porous sheet 172 shown in FIG. 7 may be generally similar to the first porous sheet 72 and therefore will not be described for simplicity with the understanding the description of the first porous sheet 72 applies equally to the first porous sheet 172.

The first porous sheet 72 may include pleats defining the first set of channels 70 and the second porous sheet 74 may include pleats defining the second set channels 76. The ratio between the height (H1) of the first set of channels 70 and the diameter of the ion exchange resin beads 68 may be at least 4-to-1 and no more than 10-to-1. Similarly, the ratio between the width (W1) of the first set of channels 70 and the diameter of the ion exchange resin beads 68 may be at least 4-to-1 and no more than 10-to-1. The second set of channels 76 may be similar to the first set of channels 70 with the ratio between the height (H2) of the second set of channels 76 and the diameter of the ion exchange resin beads 68 being at least 4-to-1 and no more than 10-to-1 and the ratio between the width (W2) of the second set of channels 76 and the diameter of the ion exchange resin beads 68 being at least 4-to-1 and no more than 10-to-1.

The ion exchange resin beads 68 may include anode resin beads 78 and cathode resin beads 80. The diameters of the anode and cathode resin beads 78, 80 may be substantially similar. In this regard, the diameter of the anode resin beads 78 may be within ten percent of the diameter of the cathode resin beads 80. The anode and cathode resin beads 78, 80 may include nuclear grade mixed bed resin. The present non-limiting example includes AMBERLITE® IRN170 Resin made commercially available from Dow Chemical.

The assembly process for the ion exchange filter cartridge 14 will be described with respect to the first and second porous sheets 72, 74 for simplicity with the understanding that the description applies equally to the first porous sheet 172 and the second sheet 174. The first and second porous sheets 72, 74 may be placed on top of one another and rolled to form the ion exchange filter exoskeleton 66. The ion exchange filter exoskeleton 66 may then be placed within the containment tube 34 at the first longitudinal end 46. After the ion exchange filter exoskeleton 66 is located within the containment tube 34, the ion exchange resin beads 68 may be loaded into an end 82 of the ion exchange filter exoskeleton 66 at the first longitudinal end 46 of the containment tube 34.

The containment tube 34 with the ion exchange filter exoskeleton 66 located therein may be vibrated in both longitudinal and lateral directions during loading of the ion exchange resin beads 68 to cause the ion exchange resin beads 68 to migrate within the ion exchange filter exoskeleton 66 and fill the first and second sets of channels 70, 76. The use of anode and cathode resin beads 78, 80 having similar diameters may assist with bead settling while maintaining the anode and cathode resin beads 78, 80 in a mixed state. The screens 42 may maintain the anode and cathode resin beads 78, 80 within the ion exchange filter exoskeleton 66. The screen 42 may be located at the end 82 after bead loading is completed.

The end cap 36 may then be fixed to the first longitudinal end 46 of the containment tube 34. As indicated above, the end cap 36 may be fixed to the containment tube 34 in a variety of ways including, but not limited to, welding. The ion exchange filter cartridge 14 may then be loaded into the housing 12 and the fastening mechanism 16 may engage the seal 38 and be secured to the housing 12 to fix the ion exchange filter cartridge 14 within the housing 12 in a sealed arrangement.

The ion exchange filter cartridge 14 may form a replaceable ion exchange filter cartridge. The fastening mechanism 16 may be removable from the housing 12 to provide for removal and replacement of the ion exchange filter cartridge 14. Therefore, the housing 12 may remain in a system without need for replacement while the ion exchange filter cartridge 14 is replaced.

The ion exchange filter assembly 10 may be used in a variety of systems including, but not limited to, vehicle fuel cell cooling systems and cooling systems for electronic components such as electronic circuits. FIG. 8 illustrates the ion exchange filter assembly 10 incorporated into a vehicle fuel cell system 84. The vehicle fuel cell system 84 may include anode and cathode plates 86, 88 and a coolant path 90 defined between the anode and cathode plates 86, 88. A coolant pump 92 may pump coolant through the coolant path 90 and through the ion exchange filter assembly 10. As seen in FIG. 8, the incorporation of the coolant bypass passage 24 within the housing 12 eliminates the need for an external bypass path in the vehicle fuel cell system 84. The integral coolant bypass passage 24 may additionally eliminate the need for a bypass control valve due to the passive flow control mechanism provided by the coolant bypass inlets 54. An external particle separation filter may also be removed from the vehicle fuel cell system 84 due to the incorporation of the particle separation filters 40 within the ion exchange filter assembly 10. Further, the size and orientation of the first set of channels 70 may inhibit migration and separation of the anode and cathode resin beads 78, 80 during vehicle operating conditions resulting in vibration of the ion exchange filter assembly 10. The size and orientation of the second set of channels 76 may further inhibit migration and separation of the anode and cathode resin beads 78, 80.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An ion exchange filter assembly comprising:
a housing adapted for receiving a coolant;
an ion exchange filter containment region defined within the housing and adapted for housing an ion exchange filter, the ion exchange filter containment region forming a first coolant flow path within the housing; and
a coolant bypass passage defined within the housing and forming a second coolant flow path in a parallel flow arrangement to the first coolant flow path.

2. The ion exchange filter assembly of claim 1, further comprising an annular wall disposed within the housing and at least partially defining the ion exchange filter containment region and the coolant bypass passage.

3. The ion exchange filter assembly of claim 2, wherein the coolant bypass passage is defined at a location radially between an exterior of the annular wall and an interior of the housing.

4. The ion exchange filter assembly of claim 3, wherein the ion exchange filter assembly defines a coolant inlet in fluid communication with the ion exchange filter containment region and the coolant bypass passage, the bypass passage including a bypass inlet defined radially through the annular wall and in communication with the coolant inlet.

5. The ion exchange filter assembly of claim 4, wherein the bypass inlet defines a passive flow control mechanism that meters coolant flow through the first and second coolant flow paths.

6. The ion exchange filter assembly of claim 2, wherein the ion exchange filter assembly defines a coolant inlet and a coolant outlet with the first and second coolant flow paths each extending from the coolant inlet to the coolant outlet and the annular wall extending longitudinally between the coolant inlet and the coolant outlet to separate the first and second coolant flow paths.

7. The ion exchange filter assembly of claim 6, wherein inlets of the first and second coolant flow paths are in communication with one another at the coolant inlet and outlets of the first and second coolant flow paths are in communication with one another at the coolant outlet.

8. The ion exchange filter assembly of claim 1, wherein the second coolant flow path surrounds the first coolant flow path and is concentric to the first coolant flow path.

9. The ion exchange filter assembly of claim 1, wherein the first coolant flow path defines a first outlet and the second coolant flow path defines a second outlet proximate the first outlet, the first and second outlets being in communication with one another at an outlet of the housing, the second coolant flow path adapted for generating a localized low pressure region in the coolant as the coolant from the second flow path flows past the first outlet.

10. The ion exchange filter assembly of claim 1, further comprising a particle separation filter located within the housing and in communication with the coolant.

11. An ion exchange filter assembly comprising:
a housing adapted for receiving a coolant;
an ion exchange filter located within the housing with a first coolant flow path defined through the ion exchange filter; and
a coolant bypass passage defined within the housing external to the ion exchange filter and forming a second coolant flow path in a parallel flow arrangement to the first coolant flow path.

12. The ion exchange filter assembly of claim 11, further comprising a fastening mechanism removably coupled to the housing, the fastening mechanism adapted for securing the ion exchange filter within the housing when engaged with the housing and for permitting removal of the ion exchange filter when disengaged from the housing.

13. The ion exchange filter assembly of claim 12, further comprising a containment tube defining a coolant inlet and a coolant outlet and having the ion exchange filter secured therein, the containment tube and the ion exchange filter forming a replaceable ion exchange filter cartridge and the fastening mechanism including a retaining ring engaged with the ion exchange filter cartridge and the housing and removably securing the ion exchange filter cartridge within the housing.

14. The ion exchange filter assembly of claim 11, wherein the coolant bypass passage is defined at a location radially between an exterior of the ion exchange filter and an interior of the housing.

15. The ion exchange filter assembly of claim 14, further comprising a containment tube defining a coolant inlet and a coolant outlet and having the ion exchange filter secured therein, the containment tube including an annular wall and the bypass passage including a bypass inlet defined radially through the annular wall and in communication with the coolant inlet.

16. The ion exchange filter assembly of claim 15, wherein the bypass inlet defines a passive flow control mechanism that meters coolant flow through the first and second coolant flow paths.

17. The ion exchange filter assembly of claim 11, wherein the ion exchange filter assembly defines a coolant inlet and a coolant outlet with inlets of the first and second coolant flow paths being in communication with the coolant inlet and outlets of the first and second coolant flow paths being in communication with the coolant outlet.

18. The ion exchange filter assembly of claim 11, wherein the second coolant flow path surrounds the first coolant flow path and is concentric to the first flow path.

19. The ion exchange filter assembly of claim 11, wherein the first coolant flow path defines a first outlet and the second coolant flow path defines a second outlet proximate the first outlet, the first and second outlet being in communication with one another at an outlet of the housing, the second coolant flow path adapted for generating a localized low pressure region in the coolant as the coolant from the second flow path flows past the first outlet.

20. The ion exchange filter assembly of claim 11, further comprising a particle separation filter located within the housing and in communication with the coolant.
